(19) United States
(12) Patent Application Publication
(10) Pub. No.: US 2012/0173282 A1
(43) Pub. Date: Jul. 5, 2012

(54) PROCESSING A PATIENT STUDY

(76) Inventor: Timothy L. Kelley, Barrington, IL (US)

(21) Appl. No.: 13/152,964

(22) Filed: Jun. 3, 2011

Related U.S. Application Data
(60) Provisional application No. 61/429,116, filed on Jan. 1, 2011.

(51) Int. Cl. G06Q 50/00

(52) U.S. Cl. 705/3

(57) ABSTRACT

Processing a patient study of a patient is provided. In one embodiment, a method of storing a patient study of a patient onto a computer-readable medium comprises obtaining a diagnostic image of the patient (480), wherein the diagnostic image includes a header; extracting the header from the diagnostic image (482); converting the diagnostic image to a non-diagnostic image (484); building a patient record using the header (486); obtaining a patient identifier using the header (488); storing the patient study to the computer-readable medium (490), wherein the patient study includes the patient identifier, the patient record, and the non-diagnostic image.

### CROSS-REFERENCE TO RELATED APPLICATION(S)

This application claims the benefit of U.S. Provisional Application No. U.S. 61/429,116 filed Jan. 1, 2011, entitled “STORING A PATIENT STUDY.” The foregoing application is incorporated herein by reference in its entirety.

### BACKGROUND

1. Field of Use

The invention generally relates to imaging systems used in medical diagnostics and in particular to processing a patient study.

2. Related Art

With the advent of the information age, various systems have been developed to capture, store, and distribute diagnostic data and images. Of these systems, the picture archiving and communications system (PACS) has achieved broad acceptance having been broadly adopted by industry. PACS allows for the storage of diagnostic data and images in a digital format. To allow for the interoperability between a PACS and various diagnostic imaging devices and associated peripherals, the digital imaging and communication in medicine (DICOM) standard was developed and adopted by the American College of Radiology (ACR) and the National Electrical Manufacturers Association (NEMA).

The DICOM standard specifies the handling, storing, printing, and transmitting of diagnostic data and images. Such standard includes a file format definition and a network communications protocol. The network communications protocol is an application protocol that uses the transmission control protocol-Internet protocol (TCP/IP) protocol to communicate between systems. DICOM files can be exchanged between two entities that are capable of receiving diagnostic data and images in DICOM format. The DICOM standard is also known as NEMA standard PS3 and ISO standard 12052.

The DICOM standard allows for the integration of various imaging equipment, including scanners, servers, workstations, printers and network equipment, from multiple manufacturers into a PACS. An imaging equipment can also be referred to as a modality. Conformance to the DICOM standard ensures that current and future imaging equipment and any related peripheral equipment interoperate regardless of the equipment's manufacturer. The DICOM standard has been widely adopted, including by hospitals, clinics, imaging centers, physicians, and specialists. Further, medical specialties such as radiology, cardiology, oncology, dentistry, surgery, neurology, breast imaging, radiotherapy, ophthalmology, pathology, veterinary, pneumology, and other medical specialties use the DICOM standard. In addition, the DICOM standard is required by electronic health record (EHR) systems that include diagnostic data and images as part of the patient study.

A DICOM file, which can also be generally referred to as a diagnostic patient study or a diagnostic image, can include a header and one or more diagnostic images. The header, which can also be referred to as diagnostic data, can include patient data and exam data. Further, extracting the header from a DICOM file can leave one or more diagnostic images. The patient data can include patient demographics such as the patient's name, identification, age, sex, birth date, size, weight, ethnicity, comments, and contact information. The exam data can include a medical record locator, study date, study time, study description, station name, accession number, study identifier, study comments, referring physician name, physician of record, performing physician name, scheduled performing physician name, operator name, admitting diagnoses description, manufacturer model name, derivation description, modality, institution name, and institution address, A DICOM file can be stored on a PACS and can be distributed using, for instance, the Internet, a compact disc (CD), or a digital versatile disk (DVD).

Accordingly, while a diagnostic file or other type of file is intended for diagnostic use by hospitals, clinics, imaging centers, specialists, and physicians for diagnostic purposes, there is a need in the art for techniques to provide diagnostic images for non-diagnostic use by patients, their friends and family, and others for training, educational, and entertainment purposes. Furthermore, other desirable features and characteristics of the present disclosure will become apparent from the subsequent detailed description and claims, taken in conjunction with the accompanying figures and the foregoing technical field and background.

### BRIEF DESCRIPTION OF THE DRAWING

in order for this disclosure to be understood and put into practice by one having ordinary skill in the art, reference is now made to examples, embodiments, and the like as illustrated by reference to the accompanying figures. Like reference numbers refer to identical or functionally similar elements throughout the accompanying figures. The figures along with the detailed description are incorporated and form part of the specification and serve to further illustrate examples, embodiments, and the like, and explain various principles and advantages, in accordance with this disclosure, where:

FIG. 1 illustrates one embodiment of a system for processing a patient study in accordance with various aspects set forth herein.

FIG. 2 illustrates one embodiment of an application program for processing a patient study with various aspects set forth herein.

FIG. 3 illustrates one embodiment of a content database associated with processing a patient study in accordance with various aspects set forth herein.

FIG. 4 is a flowchart of one embodiment of a method of storing a patient study onto a computer-readable medium in accordance with various aspects set forth herein.

FIG. 5 is a flowchart of another embodiment of a method of storing a patient study onto a computer-readable medium in accordance with various aspects set forth herein.

FIG. 6 illustrates another embodiment of a system for processing a patient study in accordance in accordance with various aspects set forth herein.

FIG. 7 illustrates one embodiment of a server program for processing a patient study in accordance with various aspects set forth herein.

FIG. 8 illustrates another embodiment of a content database associated with processing a patient study in accordance with various aspects set forth herein.

FIG. 9 is a flowchart of one embodiment of a method of storing a patient study onto a server in accordance with various aspects set forth herein.

FIG. 10 is a flowchart of another embodiment of a method of storing a patient study onto a server in accordance with various aspects set forth herein.

FIG. 11 is a flowchart of another embodiment of a method of storing a patient study onto a server in accordance with various aspects set forth herein.

FIG. 12 is a flowchart of another embodiment of a method of storing a patient study onto a server in accordance with various aspects set forth herein.

FIG. 13 is a flowchart of one embodiment of a method of delivering a patient study in accordance with various aspects set forth herein.

FIG. 14 is a flowchart of one embodiment of a method of receiving a patient study in accordance with various aspects set forth herein.

Skilled artisans will appreciate that elements in the accompanying figures are illustrated for clarity, simplicity and to further improve understanding of the examples, embodiments, and the like, and have not necessarily been drawn to scale.

### DETAILED DESCRIPTION

Although the following discloses exemplary methods, devices, and systems for use in processing a patient study, it will be understood by one of ordinary skill in the art that the teachings of this disclosure are in no way limited to those examples, embodiments, and the like. On the contrary, it is contemplated that the teachings of this disclosure may be implemented in alternative configurations and environments. Accordingly, while the following describes exemplary methods, devices, and systems of use thereof, persons of ordinary skill in the art will appreciate that the disclosed examples, embodiments, and the like are not the only way to implement such methods, devices, and systems, and the drawings and descriptions should be regarded as illustrative in nature and not restrictive.

The various aspects described herein may be implemented as a method, a device or apparatus, a system, or an article of manufacture using standard programming or engineering techniques to produce software, firmware, hardware, or any combination thereof. The various aspects described herein are presented as examples, embodiments, and the like that can include a number of components, devices, elements, members, modules, databases, threads, processes, peripherals, or the like. Further, these examples, embodiments, and the like can include or not include additional components, devices, elements, members, modules, databases, threads, processes, peripherals, or the like.

In addition, the various aspects described herein may be implemented as code maintained in a “computer-readable medium,” wherein a processor may read and execute the code from the computer-readable medium. A computer-readable medium may comprise media such as a magnetic storage medium such as a hard disk drive, a floppy disk, or a tape; an optical storage medium such as a compact disk (CD), a CD read-only memory (CD-ROM), CD recordable (CD-R), CD recordable and writable (CD-RW), a digital video disk or digital versatile disk (DVD), a DVD read only memory (DVD-ROM), a DVD recordable (DVD-R), a DVD random access memory (DVD-RAM), or an optical disk; a volatile memory device such as a random access memory (RAM) and a dynamic random access memory (DRAM); a non-volatile memory device such as a read only memory (ROM), an electrically-erasable programmable ROM (EEPROM), a programmable ROM (PROM), a static RAM (SRAM), a flash memory, firmware, programmable logic, and a magneto-resistive RAM (MRAM). The code implementing the described operations may further be implemented in hardware logic such as an integrated circuit (IC) chip, an application specific IC (ASIC) chip, and a programmable gate array (PGA).

The code or logic implementing the various aspects described herein may be implemented in a “transmission signal,” where the transmission signal may propagate through space or through a transmission media, such as an optical fiber and a copper wire. The transmission signal in which the code or logic is encoded may further include a wireless signal, a satellite transmission, a radio wave, an infrared signal, a Bluetooth signal, and a Wi-Fi The transmission signal in which the code or logic is encoded is capable of being transmitted by a transmitting station or device and received by a receiving station or device, where the code or logic encoded in the transmission signal may be decoded and stored in hardware or a computer-readable medium at the receiving and transmitting stations or devices.

An “article of manufacture” includes a computer-readable medium, hardware logic, or a transmission signal in which code may be implemented. A device in which the code implementing the various aspects described herein is encoded may include a computer-readable medium or hardware logic. Those skilled in the art will recognize that many modifications may be made to this configuration without departing from the scope of the present disclosure, and that the article of manufacture may comprise a suitable information-bearing medium known in the art.

The term “or” is intended to mean an inclusive “or” rather than an exclusive “or.” The terms “a” and “an” are intended to mean one or more unless specified otherwise or clear from the context to be directed to a singular form. The terms “an embodiment,” “the embodiment,” “the embodiments,” “other embodiment,” “other embodiments,” “one embodiment,” “one or more embodiments,” “some embodiments,” and other variations thereof mean one or more but not all of the embodiments of the present disclosure, unless expressly specified otherwise. The terms “comprising,” “including,” “having,” and other variations thereof mean including but not limited to, unless expressly specified otherwise. The enumerated listing of items does not imply that any or all of the items are mutually exclusive, unless expressly specified otherwise. Relational terms described herein such as “above” and “below,” “left” and “right,” “first” and “second,” and the like may be used solely to distinguish one entity or action from another entity or action without necessarily requiring or implying any actual such relationship or order between such entities or actions.

Devices that are in communication with each other need not be in continuous communication with each other, unless expressly specified otherwise. In addition, devices that are in communication with each other may communicate directly or indirectly, periodically or aperiodically, synchronously or asynchronously. Further, devices that are in communication with each other may communicate indirectly via one or more intermediaries. A description of an embodiment with components in communication with each other does not imply that all such components are required. Although process steps, method steps, algorithms, or the like may be described in a sequential order, such processes, methods, algorithms, or the like may be configured to operate in alternative orders. The steps of processes and methods described herein may be performed in any order practical. Further, some steps may be performed simultaneously or concurrently.

When a single device or article of manufacture is described herein, it will be readily apparent that more than one device or article of manufacture whether or not they cooperate may be used in place of a single device or article of manufacture. Similarly, where more than one device or article of manufacture is described herein whether or not they cooperate, it will be readily apparent that a single device or article of manufacture may be used in place of the more than one device or article of manufacture or a different number of devices or articles of manufacture may be used instead of the shown number of devices or programs. The functionality or the features of a device may be alternatively embodied by one or more other devices, which are not explicitly described as having such functionality or features. Thus, other embodiments of the present disclosure need not include the device itself.

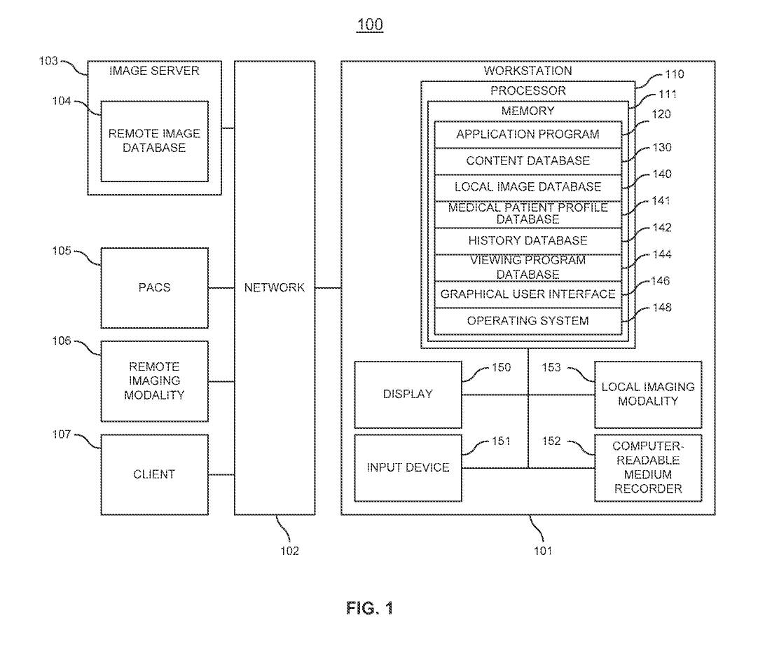

FIG. 1 illustrates one embodiment of a system 100 for processing a patient study in accordance with various aspects set forth herein. In FIG. 1, the system 100 can be configured to include a workstation 101, a network 102, an image server 103, a PACS 105, a remote imaging modality 106, client 107, or any combination thereof, which can be utilized by the system 100 to implement various aspects described herein. The workstation 101 can be configured to include a processor 110 coupled to a memory 111, which can include a graphical user interface 146 and an operating system 148 to execute an application program 120. The application program 120 can be configured to perform the functions associated with processing a patient study. Further, the application program 120 can be configured to access a content database 130, a local image database 140, a medical patient profile database 141, a history database 142, a viewing program database 144, other database, or any combination thereof. The graphical user interface 146 can be configured to produce a display to a display 150. Also, the graphical user interface can be configured to be manipulated by an input device 151. The application program 120 can also be configured to access a computer-readable medium recorder 152, a local imaging modality 153, other device, or any combination thereof. The image server 103 can be configured to include a remote image database 104, which can be utilized by the image server 103 to implement various aspects described herein.

In FIG. 1, the workstation 101 can be configured to connect via the network 102 to the image server 103, the PACS 105, the remote imaging modality 106, the client 107, other device, or any combination thereof. A user of the workstation 101 can use the application program 120 to import, convert, produce, display, send, query, store, process, edit, retrieve, anonymize, mask, print, other function, or any combination thereof a diagnostic image, a non-diagnostic image, or both obtained from the image server 103, the PACS 105, the remote imaging modality 106, the local image database 140 of the workstation 101, other source, or any combination thereof. As described previously, the diagnostic image can include a header. Further, the diagnostic image can be, for instance, a DICOM file. The format of the header and diagnostic image can be a DICOM format. The format of a non-diagnostic image can be, for instance, a portable data format (PDF), a tagged image file format (TIFF), a joint photographers experts group (JPEG) format, a graphics interchange format (GIF), a portable network graphics (PNG) format, a motion picture experts group (MPEG) video, an audio video interleave (AVI) video, a hyper text markup language (HTML) format, and an Adobe© Flash® player format.

For example, the workstation 101 can use the application program 120 to import a diagnostic image from the PACS 105, which can include a header; extract the header from the diagnostic image; convert the diagnostic image to a non-diagnostic image; and store the non-diagnostic image to a computer-readable medium using the computer-readable medium recorder 152. In a similar example, the workstation 101 can use the application program 120 to import a diagnostic image from the image server 103; extract the header from the diagnostic image; convert the diagnostic image to a non-diagnostic image; and store the non-diagnostic image to a computer-readable medium using the computer-readable medium recorder 152. The image server 103 can be configured to store diagnostic images, non-diagnostic images, or both to the remote image database 104.

In FIG. 1, the content database 130 can be configured to include educational content, advertisement content, services content, other content, or any combination thereof. The local image database 140 can be configured to include diagnostic images, non-diagnostic images, or both. The medical patient profile database 141 can be configured to include electronic health information such as information conforming to the Health Level Seven (HL7) standard. The history database 142 can be configured to include audit records of functions performed by the application program 120 such as each computer-readable medium produced. The viewing program database 144 can be configured to include a viewing program for each type of diagnostic image, non-diagnostic image, or both.

In this embodiment, the network 102 can be configured as an intranet network, the Internet, an Ethernet network, an ad hoc network, a wireline network, a wireless network, a Wi-Fi network, other similar network, or any combination thereof. Further, the network 102 can be configured to use the TCP/IP protocol, point-to-point (PPP) protocol, another similar communication protocol, or any combination thereof. For example, the network 102 is the Internet utilizing TCP/IP. In another example, the network 102 is an intranet utilizing TCP/IP. The image server 103 can be configured to connect via the network 102 to the workstation 101, the PACS 105, the remote imaging modality 106, the client 107, other device, or any combination thereof.

In FIG. 1, the image server 103 can be configured to receive a diagnostic image, a non-diagnostic image, or both from the PACS 105, the remote imaging modality 106, the workstation 101, other device, or any combination thereof and can be configured to store such image in its remote image database 104. The diagnostic image can be, for instance, a DICOM file. For example, the image server 103 can receive a DICOM file from the PACS 105. In another example, the image server 103 can receive a DICOM file from the remote imaging modality 106. The remote imaging modality 106 can be a magnetic resonance imaging (MRI) device, an ultrasound device, an x-ray device, a computerized tomography (CT) scan device, a computerized axial tomography (CAT) scan device, an image scanner device, another similar device, or any combination thereof. Similarly, the PACS 105 can receive a diagnostic image from the remote imaging modality 106 or other modality.

In this embodiment, the client 107 can be configured as a desktop computer, a laptop computer, a computer appliance, a tablet computer, a wireless device, a smartphone, a web browser device, or any other similar device. Further, the client 107 can be configured to include an e-mail application and a web browser application such as Microsoft© Internet Explorer® web browser, Mozilla© Firefox® web browser; or another similar web browser. The client 107 can be configured for use by hospitals, clinics, imaging centers, specialists, physicians, and others to access via the network 102 a diagnostic image stored on the PACS 105, the workstation 101, the image server 103, other device, or any combination thereof.

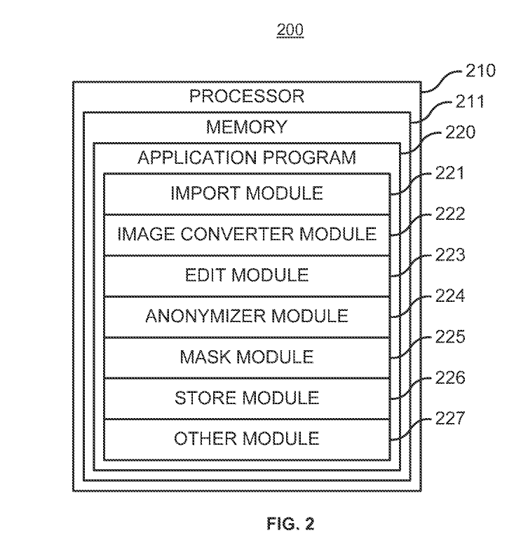

FIG. 2 illustrates one embodiment of an application program structure 200 for processing a patient study with various aspects set forth herein. In FIG. 2, the structure 200 can be configured to include a processor 210 coupled to a memory 211, wherein the memory 211 can be configured to include an application program 220 to implement various aspects described herein. The application program 220 can be configured to include an import module 221, an image converter module 222, an edit module 223, an anonymizer module 224, a mask module 225, a store module 226, and another module 227.

In this embodiment, the import module 221 can be configured to import a diagnostic image file, a non-diagnostic image file, or both from the local image database 140 or a device directly or indirectly coupled to the workstation 101 such as the local imaging modality 153, the computer-readable medium recorder 152, another device, or any combination thereof. Further, the import module 221 can be configured to import a diagnostic image, a non-diagnostic image, or both from the image server 103, the PACS 105, the remote imaging modality 106, other device, or any combination thereof, wherein such devices are accessed via the network 102. The import module 221 can also be configured to apply import rules to perform automatic changes to the diagnostic image, non-diagnostic image, or both during the import process.

In FIG. 2, the image converter module 222 can be configured to convert a diagnostic image to a non-diagnostic image using one of many image conversion techniques known to a person of ordinary skill in the art. The edit module 223 can be configured to add, edit, or delete all or a portion of any information used or accessed by the application program 220. For example, the edit module 223 can edit the patient demographics found in the header of a diagnostic image during import. In addition, the edit module 223 can be configured to edit the diagnostic image. For example, the edit module 223 can be used to remove measurement data, header information, other information, or any combination thereof from a diagnostic image. In another example, the edit module 223 can be used to remove from a diagnostic image any information considered inappropriate for patient viewing. In another example, the diagnostic image can include an overlay, wherein the overlay can include information considered inappropriate for patient viewing. The edit module 223 can be configured to modify, delete, or remove such overlay.

In this embodiment, the anonymizer module 224 can be configured to anonymize the header of a diagnostic image by, for instance, replacing, deleting, randomizing, anonymizing, encrypting, substituting, other similar function, or any combination thereof all or a portion of the information contained in the header. The mask module 225 can be configured to mask all or a portion of a diagnostic image, non-diagnostic image, or both by, for instance, placing a mask over the desired portion of the image. For example, the mask module 225 can be used to place an opaque mask over all or a portion of a diagnostic image, wherein such portion, e.g. diagnostic measurement, is not intended for diagnostic viewing.

In FIG. 2, the store module 226 can be configured to store a diagnostic image file, a non-diagnostic image file, or both to the local image database 140 or a device directly or indirectly coupled to the workstation 101 such as the local imaging modality 153, the computer-readable medium recorder 152, another device, or any combination thereof. Further, the store module 226 can be configured to store a diagnostic image, a non-diagnostic image, or both to the image server 103, the PACS 105, another device, or any combination thereof, wherein such device is accessed via the network 102. The store module 226 can also be configured to apply export rules to automatically perform changes to the diagnostic image during the store process. The other module 227 can be configured to provide other functionality to the user of the application program 220 such as the ability to receive on-line support, e-mail support, purchase supplies, search media, log activity, and configure the application program 220.

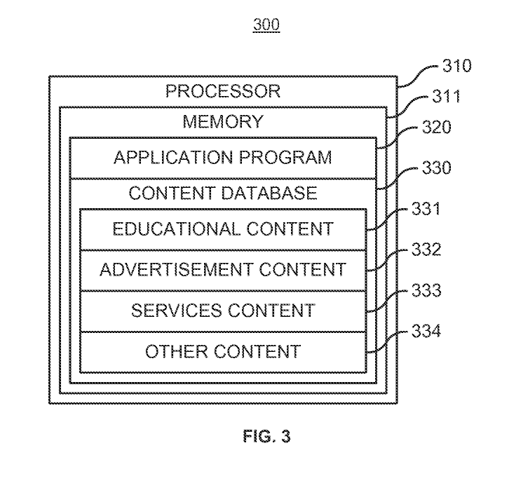

FIG. 3 illustrates one embodiment of a content database structure 300 associated with processing a patient study in accordance with various aspects set forth herein. The content database structure 300 can be configured to include a processor 310 coupled to a memory 311, wherein the memory 311 can include an application program 320 and a content database 330 to implement various aspects described herein. The application program 320 can be configured to access the content database 330. The content database 330 can be configured to include an educational content 331, an advertisement content 332, a services content 333, another content 334, or any combination thereof. The educational content 331 can be configured to include healthcare educational content, medical educational content, physical therapy educational content, pre-natal care educational content, post-natal care educational content, other educational content, or any combination thereof. The advertisement content 332 can be configured to include a healthcare advertisement, a pharmaceutical advertisement, a medical services advertisement, a product discount coupon, another advertisement, or any combination thereof. For example, the advertisement content 332 can include an advertisement for diapers. The services content 333 can be configured to include healthcare services content, physical therapy services content, other services content, or any combination thereof. The other content 334 can be configured to include, for instance, a medical form, a map, pharmaceutical information, pathology information, other information, or any combination thereof.

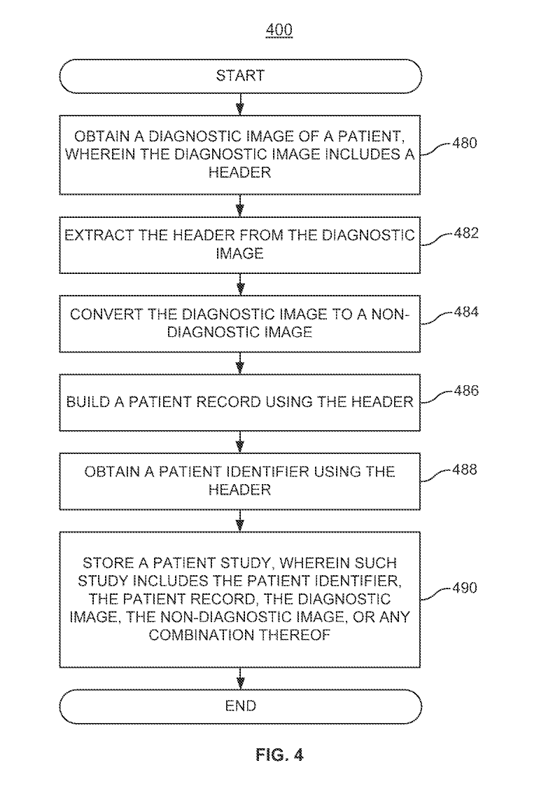

FIG. 4 is a flowchart of one embodiment of a method 400 of storing a patient study onto a computer-readable medium with various aspects set forth herein. In FIG. 4, the method 400 can start at, for instance, block 480, where the method 400 can obtain a diagnostic image of a patient, wherein the diagnostic image includes a header. The diagnostic image can be in a DICOM format or other similar format. The method 400 can import the diagnostic image via the network 102 from an image server 103, a PACS 105, a remote imaging modality 106, another device, or any combination thereof. Further, the method 400 can import a diagnostic image directly or indirectly from a local device such as the local imaging modality 153, the computer-readable medium recorder 152, the local image database 140, other device, or any combination thereof.

At block 482, the method 400 can extract all or a portion of the header from the diagnostic image. As mentioned previously, the header can include patient data and exam data. The header can contain data fields associated with the patient such as a patient name, a patient ID, a patient birth date, a patient comment, a patient sex, a patient age, a patient size, a patient weight, another data field, or any combination thereof. Further, the header can contain data fields associated with the examination such as a station name, an accession number, a study ID, a study comment, a referring physician name, a physician of record, a performing physician name, a scheduled performing physician name, an operator name, an admitting diagnoses description, a manufacturer model name, a derivation description, a modality, an institution name, an institution address, another data field, or any combination thereof. At block 484, the method 400 can convert the diagnostic image to a non-diagnostic image. The diagnostic image can be converted to a non-diagnostic image by using one of many image conversion techniques known to a person of ordinary skill in the art. For example, the method 400 can convert the diagnostic image to a JPEG-formatted, non-diagnostic image. In another example, the method 400 can convert the diagnostic image to a PDF-formatted, non-diagnostic image. A person of ordinary skill in the art will recognize that converting an image from one format to another format can result in degradation in the quality of such image, wherein such degradation may be sufficient to make such image inappropriate for diagnostic use. At block 486, the method 400 can be configured to build a patient record using the header. The method 400 can use any data field or combination of data fields of the header to build the patient record. For example, the method 400 can use the patient name, patient ID, medical record locator, study date, study time, study description, study ID, study comment, referring physician name, and the modality data fields to build the patient record. In another example, the method 400 can use the patient name data field to build the patient record.

At block 488, the method 400 can obtain a patient identifier using the header of the diagnostic image. The method 400 can use any data field or combination of data fields of the header to build a patient identifier. The patient identifier can be used to identify the patient study such as the filename of the patient study. For example, method 400 can use the patients name and study date data fields to build the patient identifier. In another example, the patient identifier can be entered by a user of the workstation 101 using the input device 151.

At block 490, the method 400 can store the patient study to a computer-readable medium using, for instance, a computer-readable medium recorder 152, wherein the patient study can include the patient identifier, the patient record, and the diagnostic image, the non-diagnostic image, or any combination thereof. The computer-readable medium recorder 152 associated with the workstation 101 can be, for instance, a CD burner, a DVD burner, a USB port, other similar device, or any combination thereof. For example, the method 400 can store the patient study to a CD using a CD burner associated with the workstation 101. As another example, the method 400 can store the patient study to a flash drive using a USB port on or associated with the workstation 101.

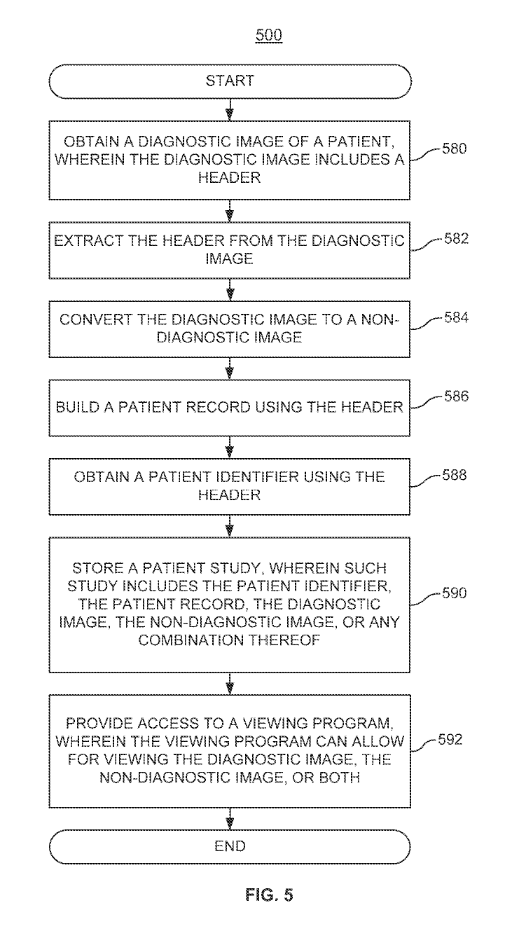

FIG. 5 is a flowchart of another embodiment of a method 500 of storing a patient study onto a computer-readable medium with various aspects set forth herein. In FIG. 5, the method 500 can start at, for instance, block 580, where the method 500 can obtain a diagnostic image of a patient, wherein the diagnostic image can include a header. The diagnostic image can be in a DICOM format or other similar format. The method 500 can import the diagnostic image via network 102 from an image server 103, a PACS 105, a remote imaging modality 106, other device, or any combination thereof. Further, the method 500 can import a diagnostic image directly or indirectly from a local device such as the local imaging modality 153, the computer-readable medium recorder 152, the local image database 140, other device, or any combination thereof.

At block 582, the method 500 can extract the header from the diagnostic image. At block 584, the method 500 can convert the diagnostic image to a non-diagnostic image. For example, the method 500 can convert the diagnostic image to an AVI-formatted, non-diagnostic image. In another example, the method 500 can convert the diagnostic image to a TIFF-formatted, non-diagnostic image. At block 586, the method 500 can build a patient record using the header. The method 500 can use any data field or combination of data fields of the header to build the patient record. For example, the method 500 can use the patient name and patient ID to build the patient record. At block 588, the method 500 can obtain a patient identifier using the header. The method 500 can use any data field or combination of data fields of the header to build a patient identifier. For example, method 500 can use the study date to build the patient identifier.

At block 590, the method 500 can store the patient study to a computer-readable medium using a computer-readable medium recorder 152, wherein the patient study can include the patient identifier, the patient record, the diagnostic image, the non-diagnostic image, or any combination thereof. For example, the method 500 can store the patient study to a CD using a CD burner associated with the workstation 101. As another example, the method 500 can store the patient study to a flash drive using a USB port on or associated with the workstation 101. At block 592, the method 500 can provide access via the computer-readable medium to a viewing program, wherein the viewing program can allow for viewing the diagnostic image, the non-diagnostic image, or both. For example, the method 500 can provide access to the viewing program via a hypertext link to a viewing program stored on, for instance, a server connected to a network 102. In another example, the method 500 can provide access to the viewing program by copying such as by downloading the viewing program from a viewing program database 144 stored on a workstation 101 to the computer-readable medium using the computer-readable medium recorder 152.

In another embodiment, a computer-readable medium can be labeled using a label. A patient identifier or other information can be written or printed onto the label. The label can be physically placed onto the computer-readable medium or can be written onto the surface of the computer-readable medium by hand or using the computer-readable medium recorder 152 or other device.

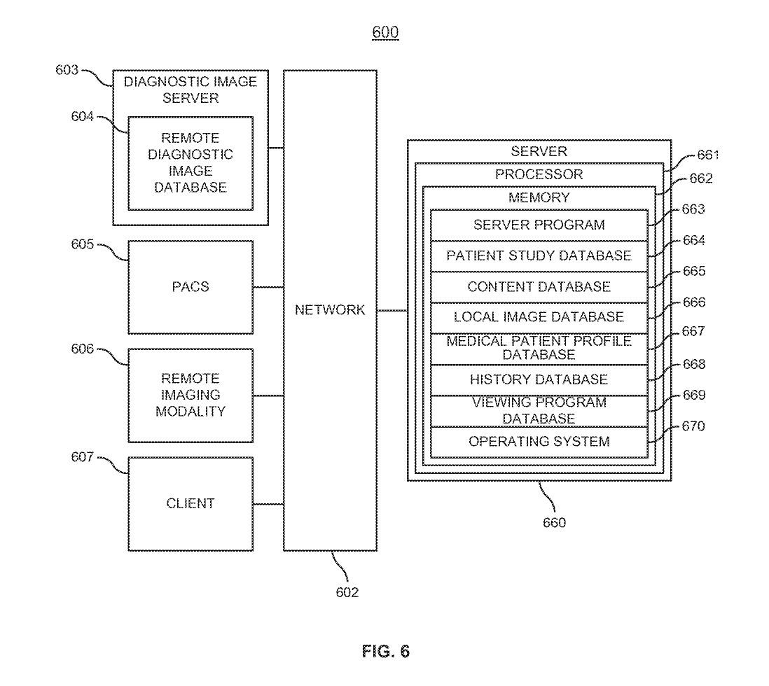

FIG. 6 illustrates another embodiment of a system 600 for processing a patient study in accordance with various aspects set forth herein. In FIG. 6, the system 600 can be configured to include a server 660, a network 602, a diagnostic image server 603, a PACS 605, a remote imaging modality 606, a client 607, or any combination thereof, which can be utilized by the system 600 to implement various aspects described herein. The server 660 can be configured to include a processor 661 coupled to a memory 662, which can include an operating system 670 to execute a server program 663. The server program 663 can be configured to implement various aspects described herein. Further, the server program 663 can be configured to access a patient study database 664, a content database 665, a local image database 140, 666, a medical patient profile database 667, a history database 668, a viewing program database 669, other database, or any combination thereof. The diagnostic image server 603 can be configured to include a remote diagnostic image database 604.

In the current embodiment, the network 602 can be configured as an intranet network, the Internet, an Ethernet network, an ad hoc network, a wireline network, a wireless network, a Wi-Fi network, other similar network, or any combination thereof. Further, the network 602 can be configured to use the TCP/IP protocol, PPP protocol, other similar communication protocol, or any combination thereof. For example, the network 602 is the Internet utilizing TCP/IP. In another example, the network 602 is an intranet utilizing TCP/IP. The diagnostic image server 603 can be configured to connect via the network 602 to the server 660, the PACS 605, the remote imaging modality 606, the client 107, other device, or any combination thereof.

In FIG. 6, the content database 665 can be configured to include educational content, advertisement content, services content, other content, or any combination thereof. The local image database 666 can be configured to include a diagnostic image, a non-diagnostic image, or both. The medical patient profile database 667 can be configured to include an electronic health information such as information conforming to the Health Level Seven (HL7) standard. The history database 668 can be configured to include audit records of each patient study delivered to the client 607. The viewing program database 669 can be configured to include a viewing program for each type of diagnostic image, non-diagnostic image, or both.

In this embodiment, the server 660 can be configured to connect via the network 602 to the image server 603, the PACS 605, the remote imaging modality 606, the client 607, other device, or any combination thereof. A user of the server 660 can use the server program 663 to import, convert, produce, display, send, query, store, process, edit, retrieve, anonymize, mask, print, other function, or any combination thereof a diagnostic image, a non-diagnostic image, or both obtained from the image server 603, the PACS 605, the remote imaging modality 606, the local image database 666 of the server 660, other source, or any combination thereof.

For example, the server 660 can use the server program 663 to import a diagnostic image from the PACS 605; extract the header information from the diagnostic image; convert the diagnostic image to a non-diagnostic image; and store the non-diagnostic image to the local image database 666. In another example, the server 660 can use the server program 663 to import a diagnostic image from the diagnostic image server 603; extract the header from the diagnostic image; convert the diagnostic image to a non-diagnostic image, and store the non-diagnostic image to the local image database 666.

In FIG. 6, the diagnostic image server 603 can be configured to receive a diagnostic image from the PACS 605, the remote imaging modality 606, the server 660, other device, or any combination thereof and can store such image in its remote image database 604. For example, the diagnostic image server 603 can receive a diagnostic image from the PACS 605. In another example, the diagnostic image server 603 can receive a diagnostic image from the remote imaging modality 606. The remote imaging modality 606 can be configured as a MRI device, an ultrasound device, an x-ray device, a CT scan device, a CAT scan device, an image scanner device, other similar devices, or any combination thereof. Similarly, the PACS 605 can be configured to receive a diagnostic image from the remote imaging modality 606 or other modality.

In this embodiment, the client 607 can be configured as a desktop computer, a laptop computer, a computer appliance, a tablet computer, a wireless device, a smartphone, a web browser device, or any other similar device. In one example, the client 607 can include an e-mail application and a web browser application such as Microsoft© Internet Explorer® web browser, Mozilla© Firefox® web browser; or other similar web browser, which can be used to access via the network 602 a diagnostic image, a non-diagnostic image, or both stored on the PACS 605, the server 660, the diagnostic image server 603, other device, or any combination thereof. In another example, the client 607 can include an application program, which can be used to access a diagnostic image, a non-diagnostic image, or both stored on the PACS 605, the server 660, the diagnostic image server 603, other device, or any combination thereof. The client 607 can be configured to be used by hospitals, clinics, imaging centers, specialists, physicians, patients, non-patients, and others to access via the network 602 a diagnostic image stored on the PACS 605, the server 660, the diagnostic image server 603, other device, or any combination thereof. Further, the client 607 can be configured to be used by hospitals, clinics, imaging centers, specialists, physicians, patients, non-patients, and others to access via the network 602 a non-diagnostic image stored on the server 660.

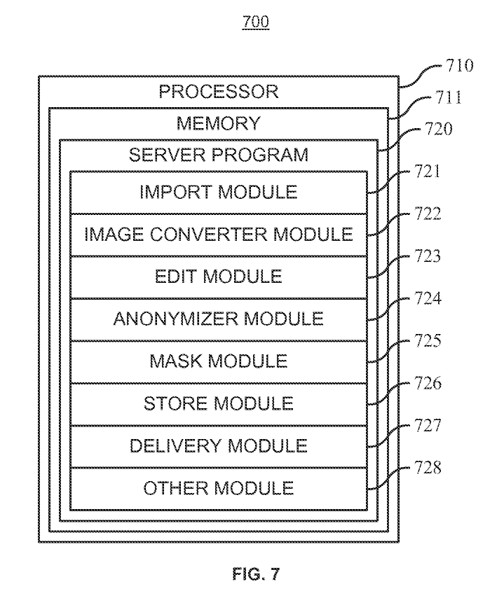

FIG. 7 illustrates one embodiment of a server program structure 700 for processing a patient study with various aspects set forth herein. In FIG. 7, the structure 700 can be configured to include a processor 710 coupled to a memory 711, wherein the memory 711 can be configured to include a server program 720 to implement various aspects described herein. The server program 720 can be configured to include an import module 721, an image converter module 722, an edit module 723, an anonymizer module 724, a mask module 725, a store module 726, a delivery module 727, and another module 228.

In this embodiment, the import module 721 can be configured to import a diagnostic image file, a non-diagnostic image file, or both from the local image database 666 or a device directly or indirectly coupled to the server 660. Further, the import module 721 can be configured to import a diagnostic image, a non-diagnostic image, or both from the image server 103, 603, the PACS 105, 605, the remote imaging modality 106, 606, other device, or any combination thereof, wherein such devices are accessed via the network 102, 602. The import module 721 can also be configured to apply import rules to perform automatic changes to the diagnostic image, the non-diagnostic image, or both during the import process.

In FIG. 7, the image converter module 722 can be configured to convert a diagnostic image to a non-diagnostic image using one of many image conversion techniques known to a person of ordinary skill in the art. The edit module 723 can be configured to add, edit, or delete all or a portion of any information used or accessed by the server program 720. For example, the edit module 723 can edit the patient demographics found in the header of a diagnostic image during import. In addition, the edit module 723 can be configured to edit the diagnostic image. For example, the edit module 723 can be used to remove measurement data, header information, other information, or any combination thereof from a diagnostic image. In another example, the edit module 723 can be used to remove from a diagnostic image any information considered inappropriate for patient viewing. In another example, the diagnostic image can include an overlay, wherein the overlay can include information considered inappropriate for patient viewing. The edit module 723 can be configured to modify, delete, or remove such overlay.

In this embodiment, the anonymizer module 724 can be configured to anonymize the header of a diagnostic image by, for instance, replacing, deleting, randomizing, anonymizing, encrypting, substituting, other similar function, or any combination thereof all or a portion of the information contained in the header. The mask module 725 can be configured to mask all or a portion of a diagnostic image, non-diagnostic image, or both by, for instance, placing a mask over the desired portion of the image. For example, the mask module 725 can be used to place an opaque mask over all or a portion of a diagnostic image, wherein such portion, e.g. diagnostic measurement, is intended for diagnostic viewing.

In FIG. 7, the store module 726 can be configured to store a diagnostic image file, a non-diagnostic image file, or both to the local image database 666 or a device directly or indirectly coupled to the server 660. Further, the store module 726 can be configured to store a diagnostic image, a non-diagnostic image, or both to the image server 103, 603, the PACS 105, 605, the remote imaging modality 106, 606, another device, or any combination thereof, wherein such device is accessed via the network 102, 602. The store module 726 can also be configured to apply export rules to automatically perform changes to the diagnostic image, non-diagnostic image, or both during the store process.

In the current embodiment, the delivery module 727 can be configured to include functionality to allow for delivery of patient studies to hospitals, clinics, specialists, physicians, patients, patients' family and friends, trainees, and others. The delivery module 727 can be configured to deliver a patient study using an e-mail, a database, a server, or other similar delivery methods. For example, the delivery module 727 can send a patient study using an e-mail, wherein the e-mail contains the patient study. In another example, the delivery module 727 can send a patient study using an e-mail, wherein the e-mail contains a hyperlink to the patient study stored in the patient study database 664 of the server 660. A user accessing the patient study via the hyperlink in the e-mail may be required to login to the server 660 prior to accessing the patient study. Further, a user accessing the patient study may be required to pay a fee prior to accessing the patient study. The other module 728 can be configured to provide other functionality to the user of the server program 720 such as the ability to receive on-line support, e-mail support, purchase supplies, search media, log activity, and configure the server program 720.

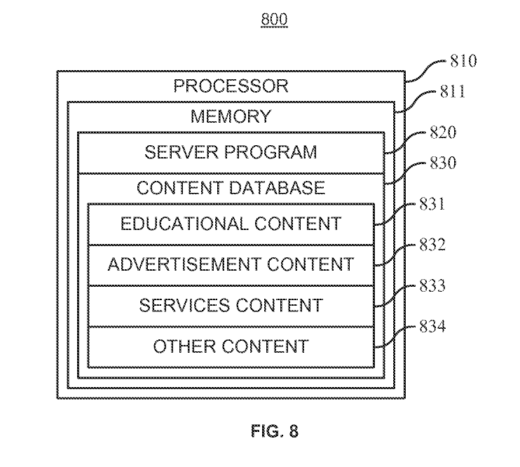

FIG. 8 illustrates another embodiment of a content database structure 800 associated with processing a patient study with various aspects set forth herein. The content database structure 800 can be configured to include a processor 810 coupled to a memory 811, wherein the memory 811 can include a server program 820 and a content database 830 to implement various aspects described herein. The server program 820 can be configured to access the content database 830.

The content database 830 can be configured to include an educational content 831, an advertisement content 832, a services content, other content 834, or any combination thereof. The educational content 831 can be configured to include healthcare educational content, medical educational content, physical therapy educational content, pre-natal care educational content, post-natal care educational content, other educational content, or any combination thereof. For example, the healthcare educational content can include educational content on pre and post-natal healthcare. The advertisement content 832 can be configured to include a healthcare advertisement, a pharmaceutical advertisement, a medical services advertisement, product discount coupons, other advertisement content, or any combination thereof. For example, the advertisement content can include an advertisement for diapers. The services content 833 can be configured to include healthcare services content, physical therapy services content, other services content, or any combination thereof. The other content 834 can be configured to include, for instance, medical forms, maps, pharmaceutical information, pathology information, other information, or any combination thereof.

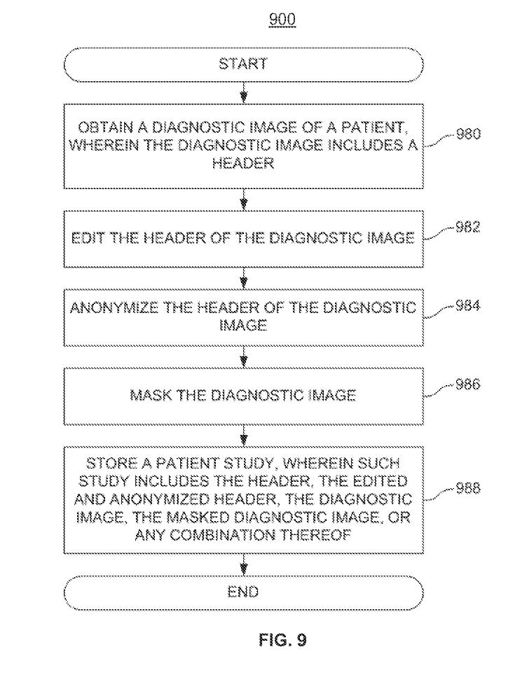

FIG. 9 is a flowchart of one embodiment of a method 900 of storing a patient study onto a server with various aspects set forth herein. In FIG. 9, the method 900 can start at, for instance, block 980, where the method 900 can obtain a diagnostic image of a patient, wherein the diagnostic image includes a header. The diagnostic image can be in a DICOM format or other similar format. The method 900 can import the diagnostic image from the image server 103, 603, the PACS 105, 605, the remote imaging modality 106, 606, the local image database 140, 666, other device, or any combination thereof. At block 982, the method 900 can edit the header of the diagnostic image.

At block 984, the method 900 can anonymize all or a portion of the header of the diagnostic image. For example, the method 900 can change, remove, delete, or modify the patient name data field in the header. At block 986, the method 900 can mask the diagnostic image. For example, the method 900 can add an opaque virtual object such as a black rectangle to an overlay of the diagnostic image to mask a portion of the diagnostic image. In another example, the method 900 can add a predetermined overlay to the diagnostic image to mask a portion of the diagnostic image. At block 988, the method 900 can store a patient study, wherein the patient study can include the edited and anonymized header, the header, the masked diagnostic image, the diagnostic image, or any combination thereof. For example, the method 900 can store the diagnostic image to the local image database 140, 666. As another example, the method 900 can store the diagnostic image to the image server 103, 603.

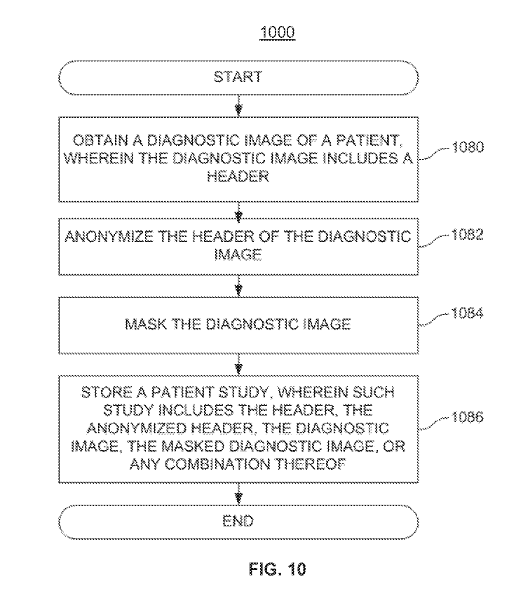

FIG. 10 is a flowchart of another embodiment of a method 1000 of storing a patient study onto a server with various aspects set forth herein. In FIG. 10, the method 1000 can start at, for instance, block 1080, where the method 1000 can obtain a diagnostic image of a patient. The diagnostic image can be in a DICOM format or other similar format. The method 1000 can import the diagnostic image from an image server 103, 603, a PACS 105, 605, a remote imaging modality 106, 606, a local image database 140, 666, other device, or any combination thereof.

At block 1082, the method 1000 can anonymize all or a portion of the header of the diagnostic image. For example, the method 1000 can change, remove, delete, or modify the patient name in the header of the diagnostic image. At block 1084, the method 1000 can mask the diagnostic image. For example, the method 1000 can add an opaque virtual object such as a black rectangle to an overlay of the diagnostic image to mask a portion of the diagnostic image. In another example, the method 1000 can add a predetermined overlay to the diagnostic image to mask a portion of the diagnostic image. At block 1086, the method 1000 can store a patient study, wherein the patient study can include the anonymized header, the header, the masked diagnostic image, the diagnostic image, or any combination thereof. For example, the method 1000 can store the patient study to the local image database 140, 666. As another example, the method 1000 can store the patient study to the image server 103, 603.

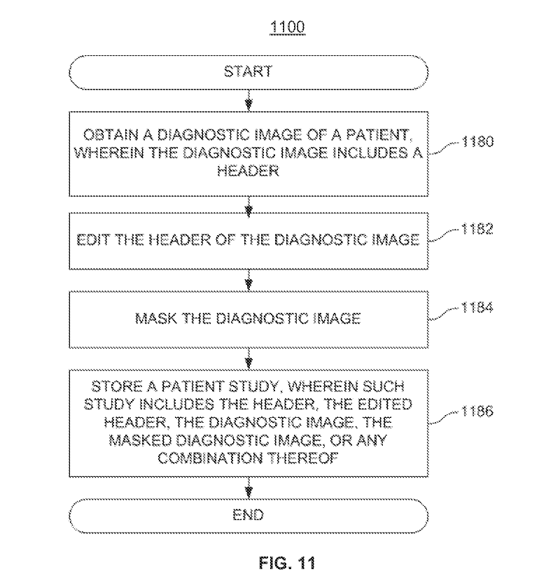

FIG. 11 is a flowchart of another embodiment of a method 1100 of storing a patient study onto a server with various aspects set forth herein. In FIG. 11, the method 1100 can start at, for instance, block 1180, where the method 1100 can obtain a diagnostic image of a patient, wherein the diagnostic image can include a header. The diagnostic image can be in a DICOM format or other similar format. The method 1100 can import the diagnostic image from an image server 103, 603, a PACS 105, 605, a remote imaging modality 106, 606, a local image database 140, 666, other device, or any combination thereof. At block 1182, the method 1100 can edit the header of the diagnostic image.

At block 1184, the method 1100 can mask the diagnostic image. For example, the method 1100 can add an object to an overlay of the diagnostic image to mask a portion of the diagnostic image. At block 1186, the method 1100 can store a patient study, wherein the patient study can include the edited header, the original header, the masked diagnostic image, the original diagnostic image, or any combination thereof. For example, the method 1100 can store the patient study to the local image database 140, 666. As another example, the method 1100 can store the patient study to the diagnostic image server 603.

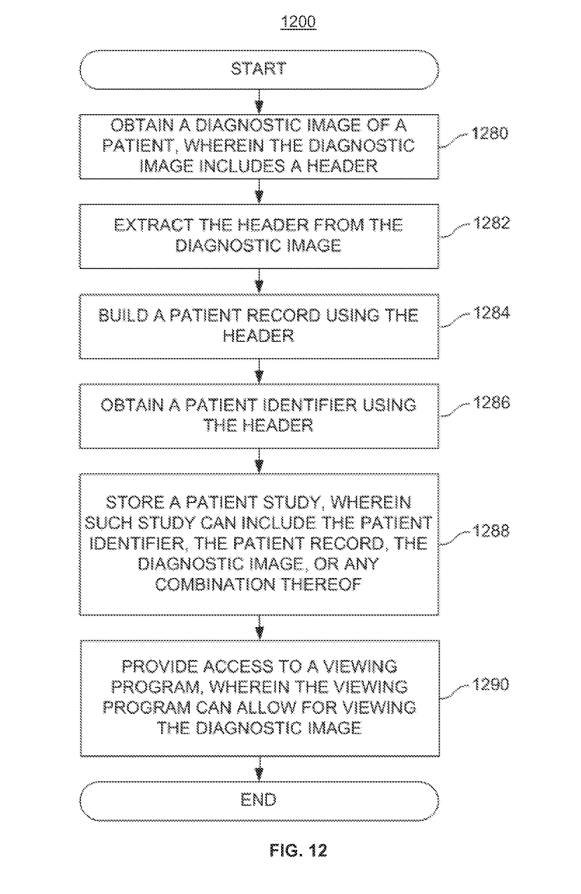

FIG. 12 is a flowchart of another embodiment of a method 1200 of storing a patient study onto a server with various aspects set forth herein. In FIG. 12, the method 1200 can start at, for instance, block 1280, where the method 1200 can obtain a diagnostic image of a patient, wherein the diagnostic image can include a header. The diagnostic image can be in a DICOM format or other similar format. The method 1200 can import the diagnostic image from an image server 103, 603, a PACS 105, 605, a remote imaging modality 106, 606, a local image database 140, 666, other device, or any combination thereof. At block 1282, the method 1200 can extract the header from the diagnostic image.

At block 1284, the method 1200 can build a patient record using the header of the diagnostic image. The method 1200 can use any data field or combination of data fields of the header to build the patient record. For example, the method 1200 can use a patient name, a patient ID, a medical record locator, a study date, a study time, a study description, a study ID, a study comment, a referring physician name, and a modality data field to build the patient record. At block 1286, the method 1200 can obtain a patient identifier using the header. The method 1200 can use any data field or combination of data fields of the header to build a patient identifier. For example, method 1200 can use a patient name. At block 1288, the method 1200 can store the patient study to a patient study database 664 of the server 660, wherein the patient study can include the patient identifier, the patient, record, the diagnostic image, or any combination thereof. At block 1290, the method 1200 can provide access to a viewing program, wherein the viewing program can allow for viewing the diagnostic image. The method 1200 can provide access to the viewing program via a hypertext link to a viewing program stored in the viewing program database 669 on the server 660 via a network 602.

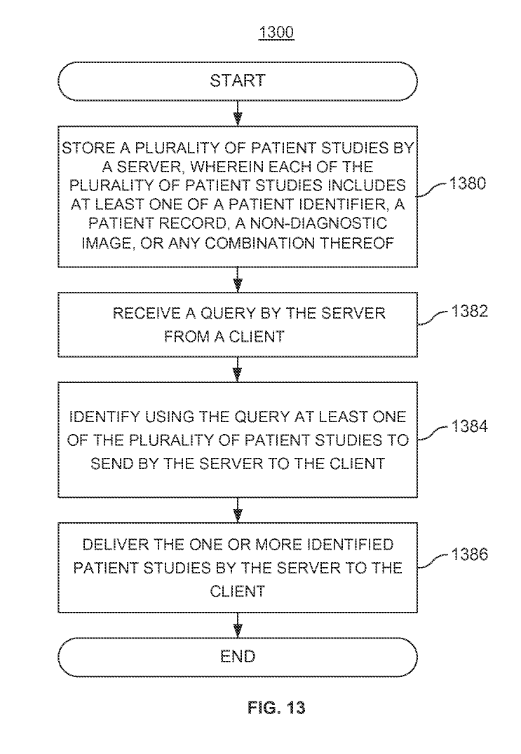

FIG. 13 is a flowchart of one embodiment of a method 1300 of delivering a patient study in accordance with various aspects set forth herein. In FIG. 13, the method 1300 can start at, for instance, block 1380, where the method 1300 can store a plurality of patient studies by a server 660, wherein each of the plurality of patient studies can include a patient identifier, a patient record, a non-diagnostic image, a diagnostic image, or any combination thereof. At block 1382, the method 1300 can receive a query by the server 660 from the client 107, 607. At block 1384, the method 1300 can identify using the query at least one of the plurality of patient studies to send by the server 660 to the client 107, 607. At block 1386, the method 1300 can send the one or more identified patient studies by the server 660 to the client 107, 607.

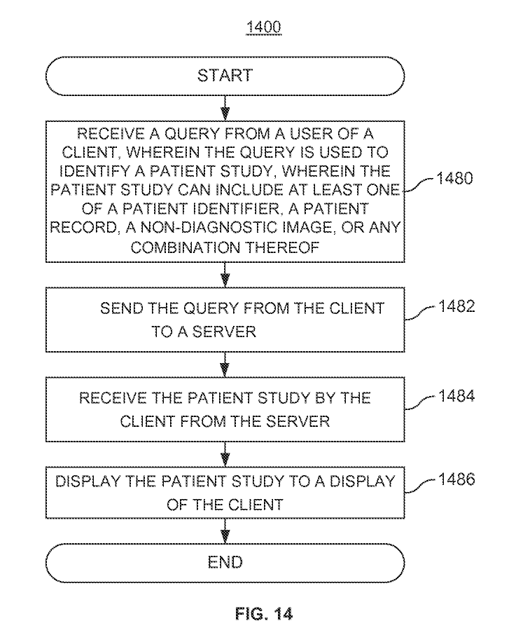

FIG. 14 is a flowchart of one embodiment of a method 1400 of receiving a patient study in accordance with various aspects set forth herein. In FIG. 14, the method 1400 can start at, for instance, block 1480, where the method 1400 can receive a query from a user of a client 107, 607, wherein the query is used to identify a patient study, wherein the patient study can include a patient identifier, a patient record, a non-diagnostic image, a diagnostic image, or any combination thereof. At block 1482, the method 1400 can send the query from the client 107, 607 to a server 660. At block 1484, the method 1400 can receive the patient study by the client 107, 607 from the server 660. At block 1486, the method 1400 can display the patient study to a display of the client 107, 607.

Having shown and described examples, embodiments, and the like further adaptations of the methods, devices, and systems described herein may be accomplished by appropriate modifications by one of ordinary skill in the art without departing from the scope of the present disclosure. Several of such potential modifications have been mentioned, and others will be apparent to those skilled in the art. For instance, the examples, embodiments, and the like discussed above are illustrative and are not necessarily required. Accordingly, the scope of the present disclosure should be considered in terms of the following claims and is understood not to be limited to the details of structure, operation, and function shown and described in the specification and drawings.

As set forth above, the described disclosure includes the aspects set forth below.

What is claimed is:

1. A method of storing a patient study of a patient onto a computer-readable medium, comprising:
obtaining a diagnostic image of the patient, wherein said diagnostic image includes a header;
extracting said header from said diagnostic image;
converting said diagnostic image to a non-diagnostic image;
building a patient record using said header;
obtaining a patient identifier using said header; and
storing the patient study to the computer-readable medium, wherein the patient study includes said patient identifier, said patient record, and said non-diagnostic image.

2. The method of claim 1, further comprising:
providing access to a viewing program via the computer-readable medium, wherein said viewing program allows for viewing said non-diagnostic image.

3. The method of claim 1, wherein the patient study further includes said diagnostic image.

4. The method of claim 3, further comprising:
providing access to a viewing program via the computer-readable medium, wherein said viewing program allows for viewing said diagnostic image.

5. The method of claim 1, wherein said obtaining a diagnostic image of the patient further comprising:
providing a graphical user interface configured to receive user input to select said diagnostic image from an imaging modality.

6. The method of claim 1, wherein said building a patient record using said header further comprising:
providing a graphical user interface configured to receive user input to enter said patient record.

7. The method of claim 1, wherein said obtaining a patient identifier of the patient further comprising:
providing a graphical user interface configured to receive user input to enter said patient identifier.

8. The method of claim 1, wherein said diagnostic image is in a digital imaging and communications in medicine (DICOM) format.

9. The method of claim 1, wherein said non-diagnostic image is in at least one of a portable data format (PDF), a tagged image file format (TIFF), a joint photographers experts group (JPEG) format, a graphics interchange format (GIF), a portable network graphics (PNG) format, a motion picture experts group (MPEG) video, an audio video interleave (AVI) video, a hyper text markup language (HTML) format, and an Adobe© Flash® player format.

10. The method of claim 1, further comprising:
storing educational content onto the computer-readable medium.

11. The method of claim 10, wherein said educational content is selected using at least one of the patient study, said header, said diagnostic image, said non-diagnostic image, said patient identifier, and said patient record.

12. The method of claim 1, further comprising:
storing advertisement content onto the computer-readable medium.

13. The method of claim 12, wherein said advertisement content is selected using at least one of the patient study, said header, said diagnostic image, said non-diagnostic image, said patient identifier, and said patient record.

14. The method of claim 1, further comprising:
storing services content onto the computer-readable medium.

15. The method of claim 14, wherein said services content is selected using at least one of the patient study, said header, said diagnostic image, said non-diagnostic image, said patient identifier, and said patient record.

16. The method of claim 1, wherein at least one of the patient study, said header, said diagnostic image, said non-diagnostic image, said patient identifier, and said patient record is encrypted.

17. The method of claim 1, wherein said obtaining a diagnostic image of the patient further includes using rules-based importing.

18. The method of claim 1, wherein at least one of the patient study, said header, said diagnostic image, said non-diagnostic image, said patient identifier, and said patient record is made anonymous.

19. A computer-readable medium having computer-executable instructions for performing a method of storing a patient study of a patient onto another computer-readable medium, comprising:
obtaining a diagnostic image of the patient, wherein said diagnostic image includes a header;
extracting said header from said diagnostic image;
converting said diagnostic image to a non-diagnostic image;
building a patient record of the patient using said header;
obtaining a patient identifier of the patient using said header;
storing the patient study to the computer-readable medium, wherein the patient study includes said patient identifier, said patient record, and said non-diagnostic image; and
providing access to a viewing program via the computer-readable medium, wherein said viewing program allows for viewing said non-diagnostic image.

20. An article of manufacture comprising a computer data signal embodied in a transmission signal for enabling a computer to perform the method of storing a patient study of a patient onto a computer-readable medium, comprising:
a first code segment to obtain a diagnostic image of the patient, wherein said diagnostic image includes a header;
a second code segment to extract said header from said diagnostic image;
a fourth code segment to convert said diagnostic image to a non-diagnostic image;
a fifth code segment to build a patient record of the patient using said header;
a sixth code segment to obtain a patient identifier of the patient using said header;
a seventh code segment to store the patient study to the computer-readable medium, wherein the patient study includes said patient identifier, said patient record, and said non-diagnostic image; and
an eighth code segment to provide access to a viewing program via the computer-readable medium, wherein said viewing program allows for viewing said non-diagnostic image.
